(19) United States
(12) Patent Application Publication
(10) Pub. No.: US 2016/0341280 A1
(43) Pub. Date: Nov. 24, 2016

(54) METHOD OF AMENDING A MULTI-STAGE GEARING APPARATUS

(71) Applicant: SIEMENS AKTIENGESELLSCHAFT, MUNCHEN (DE)

(72) Inventor: Frans Hulshof, Winterswijk (NL)

(73) Assignee: SIEMENS AKTIENGESELLSCHAFT, MUNCHEN (DE)

(21) Appl. No.: 14/718,981

(22) Filed: May 21, 2015

(51) Int. Cl. F16H 1/22

(52) U.S. Cl. CPC F16H 1/22

(57) ABSTRACT

A method of amending a multi-stage gearing apparatus comprising:
a main shaft (100);
at least one bull gear (102, 104) on said main shaft (100);
a number of intermediate gears (114, 116, 118, 120) located around a perimeter of said bull gear (102, 104);
each one of said intermediate gears (114, 116, 118, 120) being connected to an intermediate shaft (124, 126, 128, 130) having a pinion (106, 107; 108, 109; 110, 111; 112, 113) that engages said bull gear (102, 104); a plurality of output shafts (142, 144, 146, 148), each one of said output shafts (142, 144, 146, 148) having an output pinion (134, 136, 138, 140) that engages two adjacent intermediate gears (114, 116, 118, 120); and, a number of rotational devices (150, 152, 154, 156), each rotational device being connected to a respective one of said output shafts (142, 144, 146, 148), characterised in

that the method comprises the following step:
adjusting the set-up of the gearing apparatus so that the mesh of at least one of the output pinions (134, 136, 138, 140) with one of the two adjacent intermediate gears (114, 116, 118, 120) is released and the at least one output pinion (134, 136, 138, 140) meshes with only one adjacent intermediate gear (114, 116, 118, 120).

### FIELD OF THE INVENTION

This invention relates to a gearbox for distributing a torque to multiple rotational devices, in particular generators.

### BACKGROUND OF THE INVENTION

U.S. Pat. No. 7,069,802B2 (Clipper Windpower Technology, Inc.) Apr. 7, 2006 describes a multi-stage gearing apparatus comprising: a main shaft; a pair of bull gears on said main shaft; a number of intermediate gears located around a perimeter of said bull gears; each one of said intermediate gears being connected to an input shaft having a double helix pinion that engages said pair of bull gears; a plurality of output shafts, each one of said output shafts having an output pinion that engages two adjacent intermediate gears; and, a number of rotational devices, each rotational device being connected to a respective one of said output shafts. Thus the gearing apparatus comprises a low-speed stage, namely the double helix pinion engaging the pair of bull gears, and a high-speed stage, namely the output pinion engaging two adjacent intermediate gears.

TESCHLER, LELAND E., Green technology: Inside an advanced wind turbine, (Cover story). MACHINE DESIGN, 05 Jun. 2008, Vol. 80, Issue 11, pages 60 to 64, Publisher: Penton, N.Y., print ISSN 0024-9114, electronic ISSN 1944-9577, downloaded on 29 Apr. 2015 from http://machinedesign.com/energy/green-technology-inside-advanced-wind-turbine, describes that the 2.5 MW Liberty wind turbine is equipped with a gearbox, called Quantum Drive®, which is built according to the above description of U.S. Pat. No. 7,069,802B2.

It is an object of this invention to present a method how to improve an existing gearbox built according to the above description of U.S. Pat. No. 7,069,802B2. It is a further object of this invention to present an improved gearbox with torque-distributing features.

### SUMMARY OF THE INVENTION

The invention is set forth and characterized in the main claims, while the dependent claims describe other characteristics of the invention.

An object of the invention is solved by a method of amending a multi-stage gearing apparatus, in this description also called “gearbox”. The gearbox comprises a main shaft; at least one bull gear on said main shaft; a number of intermediate gears located around a perimeter of said bull gear; each one of said intermediate gears being connected to an intermediate shaft having an intermediate pinion that engages said bull gear; a plurality of output shafts, each one of said output shafts having an output pinion that engages two adjacent intermediate gears; and a number of rotational devices, e.g. generators, each rotational device being connected to a respective one of said output shafts. The method is characterized in that it comprises the following steps:
adjusting the set-up of the gearing apparatus so that at least one of the output pinions has different center distances to its adjacent intermediate gears and only can receive torque from the adjacent intermediate gear to which the output pinion has the smaller center distance.

The gear mesh of the output pinion with the adjacent intermediate gear to which the output pinion has the larger center distance—the sum of both unequal center distances after the adjustment is equal to the sum of the previous identical center distances—has a substantial increase in backlash, so that, taken in consideration all tolerances that matter, there is no contact between the gear flanks of the output pinion and that intermediate gear.

Another object of the invention is solved by a multi-stage gearing apparatus comprising a main shaft; at least one bull gear on said main shaft; a number of intermediate gears located around a perimeter of said bull gear; each one of said intermediate gears being connected to an intermediate shaft having an intermediate pinion that engages said bull gear; a plurality of output shafts, each one of said output shafts having an output pinion that meshes and has gear flank contact with only one adjacent intermediate gear and can receive torque only from this one adjacent intermediate gear; and, a number of rotational devices, each rotational device being connected to a respective one of said output shafts.

The inventor has realized that the fact that, in a gearbox built according to the above description of U.S. Pat. No. 7,069,802B2, each one of the output shafts has an output pinion that engages two adjacent intermediate gears at the same time, leads to uneven load distribution in the four branches of the main stage and in the high speed stage assuming uniform loads at the output shafts. The power from the main shaft to the plurality of output shafts with an arrangement of shafts and gears as described in U.S. Pat. No. 7,069,802,B2 can flow along different transmission paths and even in such a way, as worst case, that one single intermediate pinion that meshes with the bull gears and one single gear mesh of an intermediate gear has to transmit the full power applied. This will result in much higher stresses in all components of the gearbox and probably result in premature failure of the gears, bearings, etc. and premature failure of the gearbox. The reasons are manifold: timing failures, i.e. offset errors of the active flanks of the intermediate gear relative to the active flanks of the intermediate pinions of the main stage in circumferential direction at operating pitch diameters, that are connected to each other in such a manner that they can transmit torque in their joints; single pitch and cumulative pitch deviations (in German: “Einzelund Summenteilungsabweichungen”), run out errors of gearings to their axis of rotation; helix angle errors (in German: “Flankenrichtungsfehler”) and profile errors (in German: “Profilabweichungen”) of the gear flanks within their tolerances, these particularly in the main stage; non-uniform radial bearing play of identical bearings and machining deviations of the gearbox housing. These errors and deviations will result in a non-uniform load sharing of the input power over the four branches in the main stage of the gearbox, i.e. the meshing of bull gears and intermediate pinions, and also in the high speed stage of the gearbox, i.e. the meshing of the intermediate gears and the output pinions. For the definition of timing it can be said that perfect timing of the intermediate gears means that in circumferential direction at operating pitch diameters the active gear flanks of the intermediate gears must have a specific, error-free position to the apex point of the active gear flanks of two opposite teeth of the double helix gearing of the intermediate pinion and that all the four intermediate shafts with mounted intermediate gear wheels of a gearbox form a set with identical timing dimensions. Preferably, this specific position and the apex point are documented in the manufacturing documents and/or drawings and marked on the parts for verifying and recognition.

Theoretically it is possible that only one of the four intermediate shafts and one intermediate gear will transmit the full power. In the high speed stages it can theoretically happen that, due to a bad combination of tolerances and timing, the total load of four generators is transmitted by a single gear mesh instead of having eight equally loaded gear meshes. This non-uniform load distribution, which is constantly changing during the running of the gearbox, will affect all gear meshes negatively and results in much higher stress levels. These higher stresses can and will probably result in premature gearbox failure. This stress can result in gearbox damages.

Although there were efforts to lower this stress by using gears with a very accurate pitch and timing tolerance and allowing a twist and bending elasticity in the drive train, the above mentioned deviations, as small as they may be, still lead to a non-uniform load distribution in the four branches and uneven loads in the two gear meshes of the high speed output pinions with their adjacent intermediate gears located 180 degrees apart. Also due to these uneven loads in the two gear meshes of each output pinion, there is a bending of the high speed output pinion shafts, and the bending elasticity of these high speed output shafts will result in a non-uniform bearing along the tooth width of the high speed gear meshes and also along the length of the teeth of the splines at the other end of these output pinions. These splines have to hold the bending moments in the high speed output shafts and transmit the torque and bending moments to the output shafts suspended in bearings.

The inventor realized that the only radical solution to reduce the internal stresses is to create independently rotating high-speed output shafts and straightforward, not internally cross-connected power transmission paths between input shaft and output shafts. According to the invention this is achieved by modifying the conventional double mesh of the output pinions with two adjacent intermediate gears by creating two different center distances between at least one of the output pinions and its two adjacent identical intermediate gears, where the sum of the two different center distances is equal to the two previous identical center distances, and to set up amended gear engagements where only at the gear mesh of the smaller center distance of the output pinion and the intermediate gear a torque can be transmitted, and the gear mesh of the increased center distance has a substantial increase in backlash so that the gear flanks here cannot make contact.

The invention achieves an economic modification of the gearbox so that internal unpredictable overloads and uneven load sharing, as are present with the conventional double gear mesh, are released and a stable and balanced power distribution is obtained.

Further advantages are achieved through preferred embodiments which are defined in the dependent claims.

Preferably, the method is characterized in that the method comprises the step of adjusting the set-up of the gearing apparatus so that the mesh of each of the output pinions with one of the two adjacent intermediate gears is released and each of the output pinions meshes with only one adjacent intermediate gear.

Preferably, the step of adjusting the set-up of the gearing apparatus so that at least one of the output pinions has different center distances to its two adjacent intermediate gears is characterized in that the adjacent intermediate gears are identical. Preferably, the adjacent intermediate gears are identical at least concerning module and number of teeth and pressure angle and helix angle.

Preferably, the method is characterized in that the method comprises the step of adjusting the set-up of the gearing apparatus so that all of the output pinions have different center distances to its two adjacent intermediate gears wherein the adjacent intermediate gears are identical.

Preferably, the method comprises the following steps:

Replacing the existing gear set, comprising a high speed output pinion and two identical intermediate gears with a certain identical center distance, by a new gear set with an identical ratio but a smaller and larger, respectively, center distance, and

Moving the output pinion sideward, i.e. in a plane lying perpendicularly to the rotational axis of the pinion, so that the pinion still can be engaged with the two concerning module, number of teeth, pressure angle and helix angle identical smaller intermediate gears but only can make gear flank contact where the intermediate gear and the output pinion have the smaller center distance whereas the output pinion has an increased backlash with the other adjacent intermediate gear to which it has a larger center distance.

Preferably, the method comprises the following steps:

positioning at least one of the output shafts and the corresponding output pinion at a new position which is obtained by rotating the at least one output shaft and the corresponding output pinion about the rotational axis of the main shaft for an angle so that each one of the rotated output pinions meshes with and has gear flank contact with only one second intermediate gear; and

connecting the rotational devices to a respective one of the newly positioned output shafts.

Preferably, the axes of rotation of the four intermediate shafts and their intermediate gears are for practical reasons located at the four corners points of a square centered on the bull gears. The axes of rotation of the adjusted output pinions are also for practical reasons located on the sides of the square and with a specified offset of half of the length of the side of this square, i.e. of the sides of the square which connect two adjacent corners of the square.

The center distance of the main stage, i.e. the meshing of the bull gears and the intermediate pinions, is half the length of the diagonal between two opposite corners of the square.

To make an assembly of the output pinion with two gear meshes, 180 degrees apart, and meshing with its two adjacent identical intermediate gears possible together with the above mentioned arrangement of output pinions and intermediate gears, it is necessary that all the output pinions and intermediate gears have a special combination of numbers of teeth and that in circumferential direction the active gear flanks of the intermediate gears have a specific position to the apex point of both the active flanks of the intermediate pinions that carries this intermediate gear and this at the two operating, pitch diameters of output pinion and intermediate gear due to the arrangement of the axes of rotation of all the intermediate shafts. This specific position of the intermediate gear on the intermediate shaft concerning the position of the active gear flanks in circumferential direction at operating pitch diameter is called “timing” and is required to make an assembly of these intermediate gears with the above mentioned axis positions possible. Also these specific positions of the four intermediate gears, connected to the intermediate shaft, so that its joint can transmit the current torque, must be theoretically exactly equal for all four intermediate shafts with their intermediate gears to have a perfect load sharing, assuming perfect gears, perfect housing and perfect bearings.

With this arrangement, an even load sharing is guaranteed. With the gearing apparatus according to the present invention, there are not, in the high speed stage, all intermediate gears and output pinions connected with each other, and there are four open branches which have no contact with their neighbor branches and that will transmit just the power of one single generator. The previously mentioned gearing housing and bearing errors and imperfect gears will result in tiny accelerations and decelerations of the rotors of the four generators, and this is just a very small ripple less than approximately 1% on the actual nominal load of the generators.

### BRIEF DESCRIPTION OF THE DRAWINGS

FIG. 1 is a side view of a gearbox according to a conventional set-up.

FIG. 2 is a front end view of a gearbox according to a conventional set-up.

FIG. 3 is a front end view of a gearbox according to an amended set-up.

FIG. 4 is a front end view of a gearbox according to a conventional set-up overlaid with an amended set-up, in order to allow an identification of the changes.

### DETAILED DESCRIPTION OF A PREFERENTIAL EMBODIMENT

The figures are schematic and not true to scale, i.e. only meant to illustrate the basic principle of the invention.

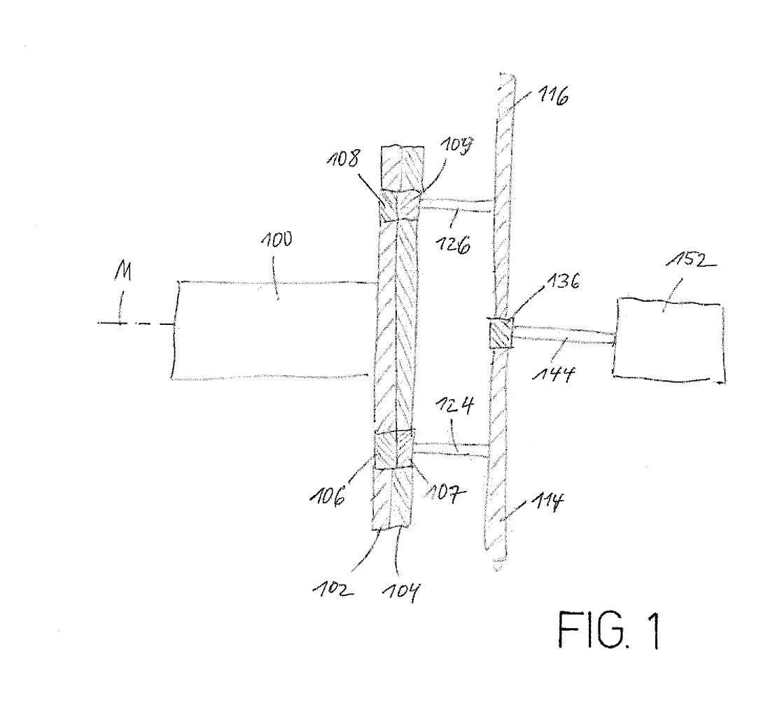

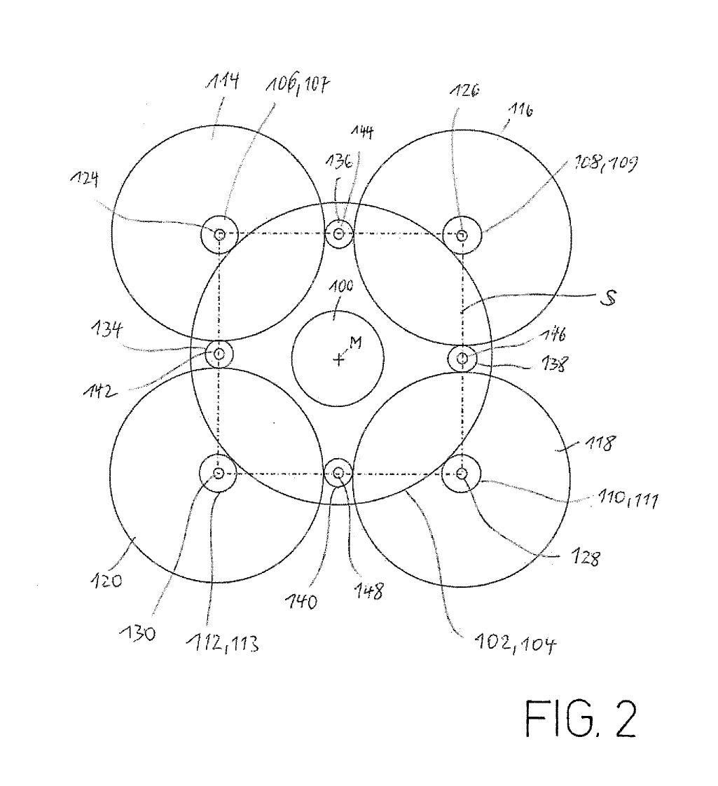

FIG. 1 is a side view and FIG. 2 a front end view of a multi-stage gearbox according to a conventional set-up, as is described, e.g., in U.S. Pat. No. 7,069,802B2. The gearbox may be used in a wind turbine to transform the slower rotation of a wind-driven rotor to the faster rotation of a generator for generation of electric energy. FIG. 1 shows only two of four intermediate shafts and one of four output shafts in order to keep the illustration easy to understand.

FIG. 2 gives a front-end view of the apparatus exactly along a rotational axis M of a main shaft 100 of the multi-stage gearing apparatus. The main shaft 100 is rotationally coupled to a rotor hub where blades of a wind-powered rotor are mounted. The main shaft 100 carries a pair of bull gears 102, 104 at that end of the shaft 100 which is situated away from the rotor hub.

Four pairs of pinions 106, 107; 108, 109; 110, 111; 112, 113 which are mounted on respective intermediate shafts 124, 126, 128, 130 mesh with the pair of bull gears 102, 104. The pair of bull gears 102, 104 are herringbone gears so that the axial force acting on the intermediate shafts 124, 126, 128, 130 is minimized. Four intermediate gears 114, 116, 118, 120, each one of said intermediate gears 114, 116, 118, 120 being connected to one of the intermediate shafts 124, 126, 128, 130, are located around a perimeter of said bull gears 102, 104.

The gearbox further comprises four output shafts 142, 144, 146, 148, each one of said output shafts 142, 144, 146, 148 having an output pinion 134, 136, 138, 140. Each of the output pinions 134, 136, 138, 140 engages two adjacent intermediate gears 114, 116, 118, 120. The four output shafts 142, 144, 146, 148 are each coupled to a respective generator 150, 152, 154, 156.

FIG. 2 shows an embodiment where the axes of rotation of the four intermediate shafts 124, 126, 128, 130 and their intermediate gears 114, 116, 118, 120 are for practical reasons located at the four corners points of a square S centered on the bull gears 102, 104. The axes of rotation of the output pinions 134, 136, 138, 140 are also for practical reasons located on and at half of the length which connects two adjacent corners of this square S, i.e. of the sides of the square S.

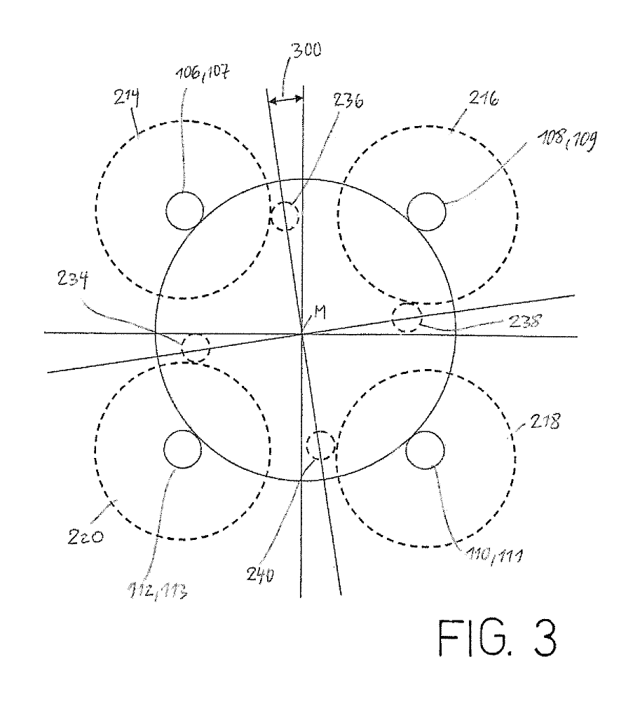

FIG. 3 is a front end view of a gearbox according to an amended set-up, illustrating the method to amend the gearing apparatus from the troubled conventional form to the amended form: According to the invention, the set-up of the gearbox is adjusted so that the conventional double mesh of each of the output pinions 134, 136, 138, 140 with two adjacent intermediate gears 114, 116, 118, 120 is changed into a single mesh: According to the invention, at least one of the output pinions 234, 236, 238, 240 meshes and has gear flank contact with only one adjacent intermediate gear 214, 216, 218, 220.

This amended set-up is achieved by positioning at least one of the output shafts and the corresponding output pinion at a new position which is obtained by rotating the at least one output shaft and the corresponding output pinion about the rotational middle axis M of the main shaft 100 for an angle 300 so that each one of the rotated output pinions 234, 236, 238, 240 meshes with and has gear flank contact with only one second intermediate gear 214, 216, 218, 220. The rotational devices, preferably generators, are connected to a respective one of the newly positioned output shafts.

The new position of the output shafts and of the output pinions can also lie on the connecting line of the rotation axes of the adjacent intermediate gears.

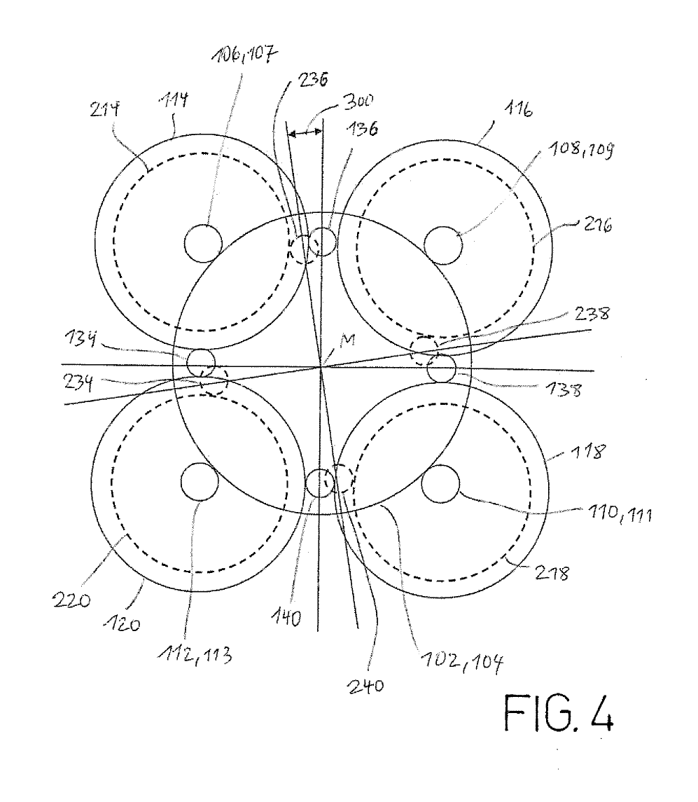

FIG. 4 is a front end view of a gearbox according to a conventional set-up overlaid with an amended set-up, in order to allow an identification of the changes.

FIG. 4 shows two different forms of the gearing apparatus: the conventional form, as is described in U.S. Pat. No. 7,069,802B2, has intermediate gears 114, 116, 118, 120 drawn in solid lines, whereas the amended form according to the invention has intermediate gears 214, 216, 218, 220 with smaller diameter, drawn in doffed lines.

The conventional form has output pinions 134, 136, 138, 140, drawn in solid lines, which mesh with two adjacent intermediate gears 114, 116, 118, 120. The amended form according to the invention has output pinions 234, 236, 238, 240, drawn in dotted lines, which have a changed position with regard to the conventional apparatus form and which mesh only with one adjacent intermediate gear 214, 216, 218, 220.

The output shafts 142, 144, 146, 148 and the corresponding output pinions 134, 136, 138, 140 according to the conventional set-up are positioned at a new position 234, 236, 238, 240 which is obtained by rotating the output shaft 142, 144, 146, 148 and the corresponding output pinion 134, 136, 138, 140 about the rotational axis M of the main shaft 100 for an angle 300 so that each one of the rotated output pinions 234, 236, 238, 240 meshes only with one second intermediate gear 214, 216, 218, 220. Furthermore, the rotational devices 150, 152, 154, 156, here: the generators, are connected to a respective one of the newly positioned output shafts 142, 144, 146, 148.

According to the embodiment illustrated in the figure, the intermediate gears 114, 116, 118, 120 are replaced by second intermediate gears 214, 216, 218, 220 having a slightly smaller diameter than the previously mounted intermediate gears 114, 116, 118, 120. For example, the shaft center distance between the intermediate shafts and the output shafts may be amended from conventional 671.5 mm to amended 665 mm. The present situation is 2×671.75 mm=1343.5 mm between the two corner points of the square S shown in FIG. 2. The amended set-up according to the invention comprises for example a smaller center distance 665 mm and a larger center distance 678.5 mm, where the sum of both is again 1343.5 mm as in the conventional set-up. The offset of the amended high speed output pinions from their conventional position is 671.75 mm−665 mm=6.75 mm.

It is possible that the rotational devices 150, 152, 154, 156, in particular the stator units of the generators, are mounted to the gearing apparatus by means of screw bolts which are screwed into and/or through bearing covers which cover bearings of the intermediate shafts 124, 126, 128, 130. Further it is possible that the generators are positioned coaxially with the output shafts 142, 144, 146, 148, so that the output shafts of the gearing apparatus is coaxially coupled to an input shaft, preferably: a rotor shaft, of the generators. Since the amended form of the gearing apparatus does not necessarily involve a change of the position of the intermediate shafts 124, 126, 128, 130, the bearing covers can stay at their conventional position when amending the gearing apparatus from the conventional to the amended form. However, if the output shafts 142, 144, 146, 148 and the corresponding output pinions 134, 136, 138, 140 are positioned at a new position 234, 236, 238, 240, the stators of the generators can be shifted to their amended position—coaxially to the newly positioned output shafts—by fixing the screw bolts at an amended position on the bearing covers or by providing amended bearing covers where the screw bolts are positioned at the amended position.

Since the gearbox housing stays unchanged and only amended bearing covers and cartridges for the output shafts are necessary in order to realize the amended gearbox form, the method to amend the existing gearbox can be executed with relatively small cost. The amended cartridges have a small offset between centering to the housing and bores for the bearings of the output shaft.

As a result of this change, the high speed output pinion cannot be flexibly borne any more but must be borne in an amended cartridge housing with a corresponding axis offset of 671.75 mm−665 mm=6.75 mm.
100 main shaft
102 bull gear
104 bull gear
106 intermediate pinion
107 intermediate pinion
108 intermediate pinion
109 intermediate pinion
110 intermediate pinion
111 intermediate pinion
112 intermediate pinion
113 intermediate pinion
114 intermediate gear, original
116 intermediate gear, original
118 intermediate gear, original
120 intermediate gear, original
124 intermediate shaft
126 intermediate shaft
128 intermediate shaft
130 intermediate shaft
134 output pinion, original
136 output pinion, original
138 output pinion, original
140 output pinion, original
142 output shaft, original
144 output shaft, original
146 output shaft, original
148 output shaft, original
214 intermediate gear, second
216 intermediate gear, second
218 intermediate gear, second
220 intermediate gear, second
234 output pinion, second
236 output pinion, second
238 output pinion, second
240 output pinion, second
300 angle
M middle axis
S square

1. A method of amending a multi-stage gearing apparatus comprising:
a main shaft (100);
at least one bull gear (102, 104) on said main shaft (100);
a number of intermediate gears (114, 116, 118, 120) located around a perimeter of said bull gear (102, 104);
each one of said intermediate gears (114, 116, 118, 120) being connected to an intermediate shaft (124, 126, 128, 130) having a pinion (106, 107; 108, 109; 110, 111; 112, 113) that engages said bull gear (102, 104);
a plurality of output shafts (142, 144, 146, 148), each one of said output shafts (142, 144, 146, 148) having an output pinion (134, 136, 138, 140) that engages two adjacent intermediate gears (114, 116, 118, 120); and, a number of rotational devices (150, 152, 154, 156), each rotational device being connected to a respective one of said output shafts (142, 144, 146, 148), characterised in
that the method comprises the following step:
adjusting the set-up of the gearing apparatus so that the mesh of at least one of the output pinions (134, 136, 138, 140) with one of the two adjacent intermediate gears (114, 116, 118, 120) is released and the at least one output pinion (134, 136, 138, 140) meshes with only one adjacent intermediate gear (114, 116, 118, 120).

2. The method of claim 1,
comprising the step of adjusting the set-up of the gearing apparatus so that the mesh of all of the output pinions (134, 136, 138, 140) with one of the two adjacent intermediate gears (114, 116, 118, 120) is released and each of the output pinions (134, 136, 138, 140) meshes with only one adjacent intermediate gear (114, 116, 118, 120).

3. The method of claim 1,
wherein the method further comprises the following steps:
replacing at least one of the intermediate gears (114, 116, 118, 120) by a second intermediate gear (214, 216, 218, 220) having a smaller diameter than the previously mounted intermediate gear (114, 116, 118, 120);
positioning at least one of the output shafts (142, 144, 146, 148) and the corresponding output pinion (134, 136, 138, 140) at a new position (234, 236, 238, 240) which is obtained by rotating the at least one output shaft (142, 144, 146, 148) and the corresponding output pinion (134, 136, 138, 140) about the rotational axis (M) of the main shaft (100) for an angle (300) so that each one of the rotated output pinions (134, 136, 138, 140) meshes with only one second intermediate gear (214, 216, 218, 220); and
connecting the rotational devices (150, 152, 154, 156) to a respective one of the newly positioned output shafts (142, 144, 146, 148).

4. The method of one of claim 1,
wherein the position of at least one of the output pinions (134, 136, 138, 140) is changed for a distance between 1 and 10 mm, preferably between 3 and 8 mm, more preferably 5 and 7 mm.

5. Multi-stage gearing apparatus comprising:
a main shaft (100);
at least one bull gear (102, 104) on said main shaft (100);
a number of intermediate gears (114, 116, 118, 120) located around a perimeter of said bull gear (102, 104);
each one of said intermediate gears (114, 116, 118, 120) being connected to an intermediate shaft (124, 126, 128, 130) having a pinion (106, 107; 108, 109; 110, 111; 112, 113) that engages said bull gear (102, 104);
a plurality of output shafts (142, 144, 146, 148), each one of said output shafts (142, 144, 146, 148) having an output pinion (134, 136, 138, 140) that meshes with only one adjacent intermediate gears (114, 116, 118, 120); and,
a number of rotational devices (150, 152, 154, 156), each rotational device being connected to a respective one of said output shafts (142, 144, 146, 148).
